(19) United States
(12) Patent Application Publication
(10) Pub. No.: US 2002/0075882 A1
(43) Pub. Date: Jun. 20, 2002

(54) Multiple priority buffering in a computer network

(76) Inventors: Marc Donis, Gainesville, FL (US); Lundy Lewis, Mason, NH (US); Utpal Datta, Bedford, NH (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/883,075

(22) Filed: Jun. 15, 2001

Related U.S. Application Data
(63) Continuation of application No. 09/074,059, filed on May 7, 1998, now abandoned.

(51) Int. Cl. H04L 12/56

(52) U.S. Cl. 370/412; 370/429

(57) ABSTRACT

Buffer element for communication network, including a first buffer memory to store communication units corresponding to a first quality of service (QOS) level, and a second buffer memory to store communication units corresponding to a second quality of service level. A buffer manager selectively stores communication units from the first and second buffers based on the corresponding quality of service level, and retrieves communication units from the first and second buffer memories. The buffer manager includes a sorter unit for selectively storing based on the quality of service level. The buffer element may further include a depth adjuster to adjust the depth of the first and second buffer memory.

### FIELD OF THE INVENTION

The invention relates to communication networks and, more particularly, to buffering received and/or transmitted communication units in a communications network.

### DISCUSSION OF THE RELATED ART

Communication networks have proliferated to enable sharing of resources over a computer network and to enable communications between facilities. A tremendous variety of networks have developed. They may be formed using a variety of different inter-connection elements, such as unshielded twisted pair cables, shield twisted pair cables, shielded cable, fiber optic cable, even wireless inter-connect elements and others. The configuration of these inter-connection elements, and the interfaces for accessing the communication medium, may follow one or more of many topologies (such as star, ring or bus). A variety of different protocols for accessing networking medium have also evolved.

A communication network may include a variety of devices (or “switches”) for directing traffic across the network. One form of communication network using switches is an Asynchronous Transfer Mode (ATM) network. These networks route “cells” of communication information across the network. (While the invention may be discussed in the context of ATM networks and cells, this is not intended as limiting.)

FIG. 1 is a block diagram of one embodiment of a network switch 10. In this particular example, the network switch has three input ports 14a-14c and three output ports 14d-14f. The switch is a unidirectional switch, i.e., data flows only in one direction—from ports 14a-14c to ports 14d-14f. A communication unit (such as an ATM cell, data packet or the like) may be received on one of the ports (e.g., port 14a) and transmitted to any of the output ports (e.g., port 14e). The selection of which output port the communication unit should receive the communication unit may depend on the ultimate destination of the communication unit (and may also depend on the source of the communication unit, in some networks).

Control units 16a-16c route communication units received on the input ports 14a-14c through a switch fabric 12 to the applicable output ports 14d- 14f. For example, a communication unit may be received on port 14a. The control unit 16a may route the communication unit (based, for example, on a destination address contained in the communication unit) through the switch fabric 12 to the buffer 16e. From there, the communication unit is output on port 14e.

The buffers 16d- 16f permit the network switch 10 to reconcile varying rates of receiving cells. For example, if a number of cells are received on the various ports 14a-14c, all for the same output port 14d, the output port 14d may not be able to transmit the communication units as quickly as they are received. Accordingly, these units may be buffered.

A great number of variations on the network switch 10 illustrated in FIG. 1 are possible. For example, control unit 16a-16c may be done in a centralized manner. As another example, the buffer in 16d-16f may be done on the input ports (e.g., as part of control units 16a-16c), rather than for the output ports. Another possibility is to use a combined buffer for input and output. This may correspond to pairing an input port with an output port. For example, input port 14a could be paired with output 14d, for the effect of a bi-directional port.

FIG. 2 illustrates buffering using separate receive and transmit buffers at the same time. In this example, network port 24 includes both an input port (e.g., port 25a) and an output port (e.g., 25d). A buffer 26 is provided for the input port. A separate buffer 28 is provided for the output port. Information may be routed through the network switch fabric 22 between ports, as generally described above.

FIG. 3 illustrates an alternative embodiment. In this embodiment, combined receive and transmit buffers are shown. In this embodiment, the receive buffer 36 and transmit buffer are stored in a common memory 35.

Another alternative would be to provide a receive buffer and a transmit buffer that include a shared memory area. Such a system is described in copending and commonly owned U.S. patent application Ser. No. 08/847,344, entitled Method And Apparatus For Adaptive Port Buffering, filed Apr. 24, 1997, by Steve Augusta et al., which is hereby incorporated by reference in its entirety.

In many networks, all communication units are treated equally—i.e., all communication units are assumed to have the same priority in traveling across a network. Alternatively, various levels of quality of service (“QoS”) may be provided. This has been applied in ATM networks, although the concept may be applied in other contexts.

In one example, different services offered over the network may have different transmission requirements. For example, video on demand may require high quality service (to avoid jerking movement in the video), while e-mail allows a lower quality of service. Subscribers may be offered the option to pay higher prices for higher levels of quality of service.

### SUMMARY OF THE INVENTION

According to one embodiment of the present invention, a buffer element for a communication network is disclosed. A first buffer memory is provided to store communication units corresponding to a first quality of service (QoS) level. A second buffer memory stores communication units corresponding to a second quality of service level. A buffer manager is coupled to the first buffer memory and the second buffer memory. A depth adjuster may be provided to adjust corresponding depths of the first buffer memory and the second buffer memory.

According to another embodiment of the present invention, a switch for a communication network is disclosed. The snitch includes a plurality of ports, a first buffer memory coupled to one of the ports to store communication units corresponding to a first quality of service level and a second buffer memory coupled to the one of the ports to store communication units corresponding to a second quality of service level.

According to another embodiment of the present invention, a method of buffering communication units in a communication network is disclosed. According to this embodiment, a queue depth is assigned for each of a plurality of queues, each queue being designated to store communication units of a predetermined quality of service level. The plurality of queues is provided, each having the corresponding assigned depth. One of the queues is selected to receive a communication unit, based on a quality of service level associated with the communication unit. The communication unit may then be stored in the selected queue. This embodiment may further comprise a step of adjusting queue depths.

According to another embodiment of the present invention, a method of selecting a communication unit for transmission in a communication network that provides a plurality of quality of service levels is disclosed. In this embodiment, the communication unit is selected from a plurality of communication units stored in a buffer, the buffer including a plurality of queues, each queue corresponding to one of the quality of service levels. The method of this embodiment includes the steps of identifying the queue with the highest corresponding quality of service level and which is not empty, and then selecting the communication unit from the identified queue.

According to another embodiment of the present invention, a method of storing a communication unit in a buffer is disclosed. According to this embodiment, the communication unit has one of a plurality of quality of service levels and the buffer includes a plurality of queues, each queue corresponding to one of the quality of service levels. According to this embodiment, the method comprises steps of determining the quality of service level of the communication unit and storing the communication unit in the queue having the corresponding quality of service level of the communication unit. According to this embodiment, the communication unit may be dropped when the queue having the corresponding quality of service level of the communication unit is full (or alternatively placed in a queue for a lower quality service).

### BRIEF DESCRIPTION OF THE DRAWINGS

FIG. 1 illustrates one embodiment of a network switch in a communication network.

FIG. 2 illustrates one embodiment of buffering for a switch.

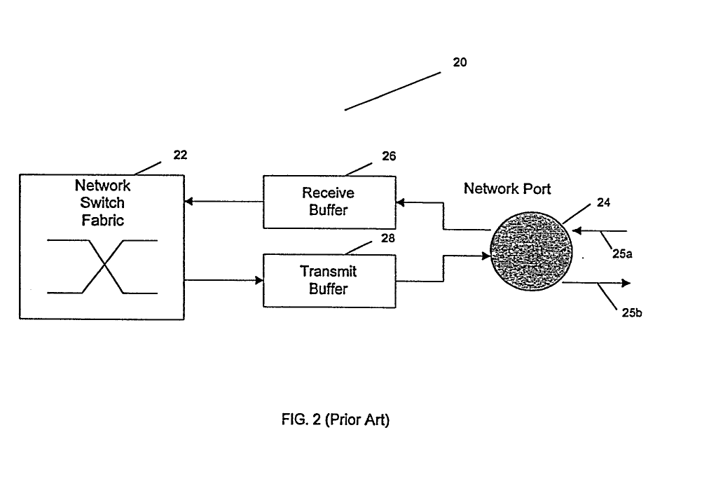

FIG. 3 illustrates another embodiment of buffering for a switch.

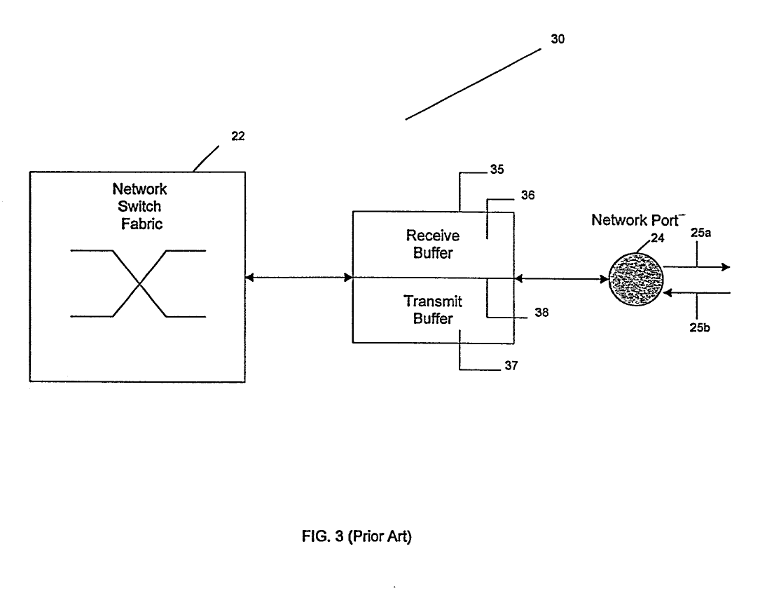

FIG. 4 illustrates one embodiment of a buffer element according to the present invention.

FIG. 5 illustrates one embodiment of a network switch according to the present invention.

FIG. 6 illustrates one embodiment of a method for receiving cells using the buffering element illustrated in FIG. 4.

FIG. 7 illustrates one embodiment of retrieving cells from a buffer element such as that shown in FIG. 4.

FIG. 8 illustrates one embodiment of a method for determining depth assignments for a buffering element.

FIG. 9 illustrates one embodiment of a graphical use r interface for in putting queue depth assignment problems.

FIG. 10 illustrates one embodiment of a buffer element and associated controllers for use in a communication network.

FIG. 11 illustrates one embodiment of a method for adjusting queue depths during use of the communication network.

### DETAILED DESCRIPTION

Design of a communication network (or a switch for use in a communication network) that supports various levels of QoS can be a difficult task. One difficulty is determining the quality of a particular implementation. Generally, the design of a communication network may pursue the following (sometimes conflicting) goals: 1) Accommodating traffic through the network; 2) Making efficient use of the network facilities; 3) Ensuring that network performance reflects the appropriate QoS levels.

Two potential measures of the quality of service offered include cell loss rate (CLR) and cell transfer delay (CTD). CLR reflects the number of cells that are lost. For example, if more cells arrive at a switch than can be accommodated in the switch's buffer, some cells may be lost.

CTD corresponds to the amount of time a cell spends at a switch (or other storage and/or transfer device) before being transmitted. For example, if a cell sits in a buffer for a long period of time while other (e.g., higher QoS level) cells are transmitted, the CTD of the delayed cell is the amount of time it spends in the buffer.

In the embodiment described below, mean cell loss rate (CLR) and mean cell transfer delay (CTD) are used to measure the quality of service. Of course a number of variations on these measures as well as other measures could be used. For example, cell delay variation (the amount of variation in cell delay) or maximum CTD (rather than average CTD) could be used as alternative or additional measures. Other measures may be used instead or as well.

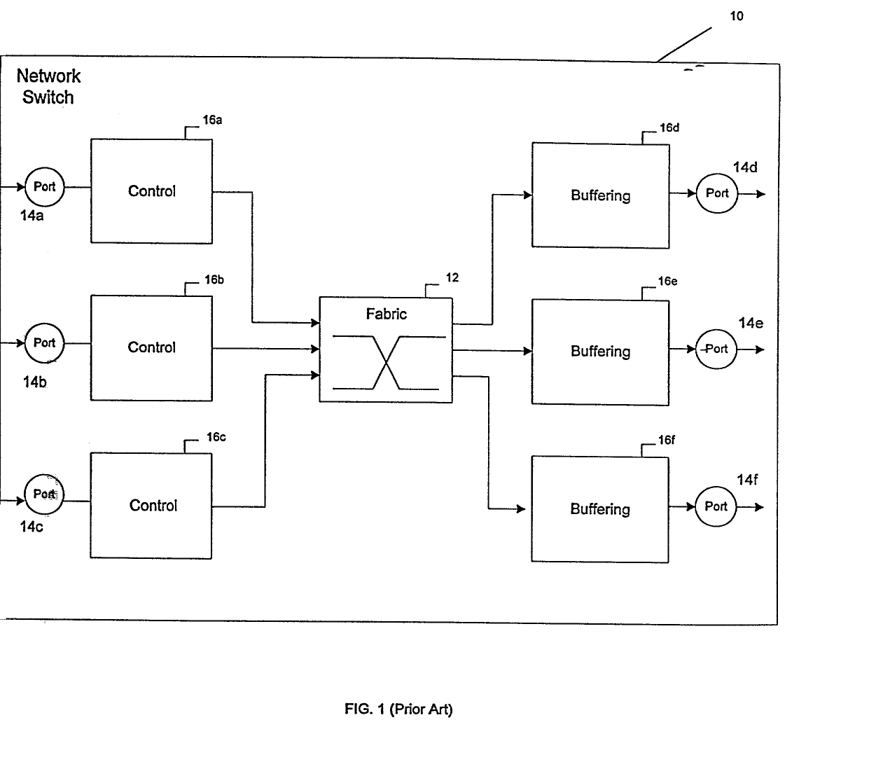

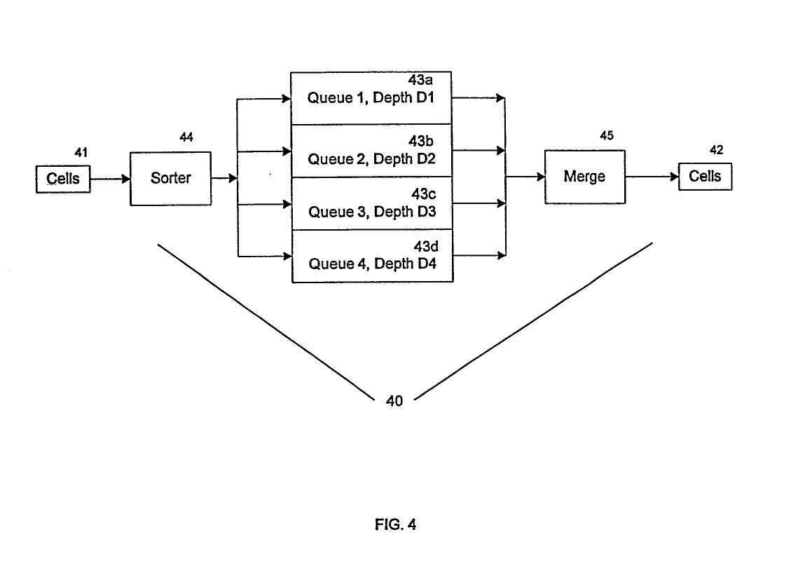

FIG. 4 illustrates one embodiment of a buffer element for use in a network accommodating multiple QoS levels. A buffering mechanism 40 is provided at a switch port, such as the buffering element 16d at port 14d of FIG. 1. In that particular example, the buffering occurs at an output port 14d. In alternative embodiments, buffering may be associated with an input port (e.g., 14a-14c of FIG. 1) or both input and output ports.

In the example of FIG. 4, the buffering element 40 includes four queues (also referred to as buffers) 43a-43d. Each queue is composed of a storage component, such as a random access memory (or any other storage device). Each queue 43a-43d is associated with a particular QoS level for the network. Thus, in the example of FIG. 4, there are four QoS levels. Queue 1 (43a) corresponds to the highest QoS level. Queue 2 (43b) corresponds to the second highest QoS level. Queue 3 (43c) corresponds to the third highest QoS level. Queue 4 (43d) corresponds to the lowest QoS level.

Each of the queues 43a-43d also has an associated depth. The depth corresponds to the amount of information that can be stored in the particular queue. Where incoming cells 41 have a fixed length, the depth of the queue may be measured by the number of cells that can be stored in that queue.

In FIG. 4, queue 1 (43a) has a depth D1. Queue 2 (43b) has a depth D2. Queue 3 (43c) has a depth D3. Queue 4 (43d) has a depth D4. Each of the depths D1-D4 may be of a different size. When incoming cells 41 are directed to the port, a sorter 44 assigns the cell to the appropriate queue 43a-43d based on the QoS of the cell. In most cases, the QoS of the cell will be indicated in an information field within the cell itself.

When a cell can be transmitted from the port, a merge unit 45 selects the appropriate cell for transmission. While the sorter 44 and merge unit 45 are shown as separate components, these may be implemented in a number of ways. For example, the sorter and merge unit may be separate hardware components. In another embodiment, the sorter 44 and merge unit 45 may be programmed on a general purpose computer coupled to the memory or memories storing queues 43a-43d. In another embodiment, a common merge unit is used for all of the ports (particularly where buffering is done on an input port).

The queues 43a-43d may be implemented using separate memories. In the alternative, the queues may be implemented in a single memory unit, or shared across multiple shared memory units. The memory units may be conventional random access memory device or any other storage element, such as shift registers or other devices.

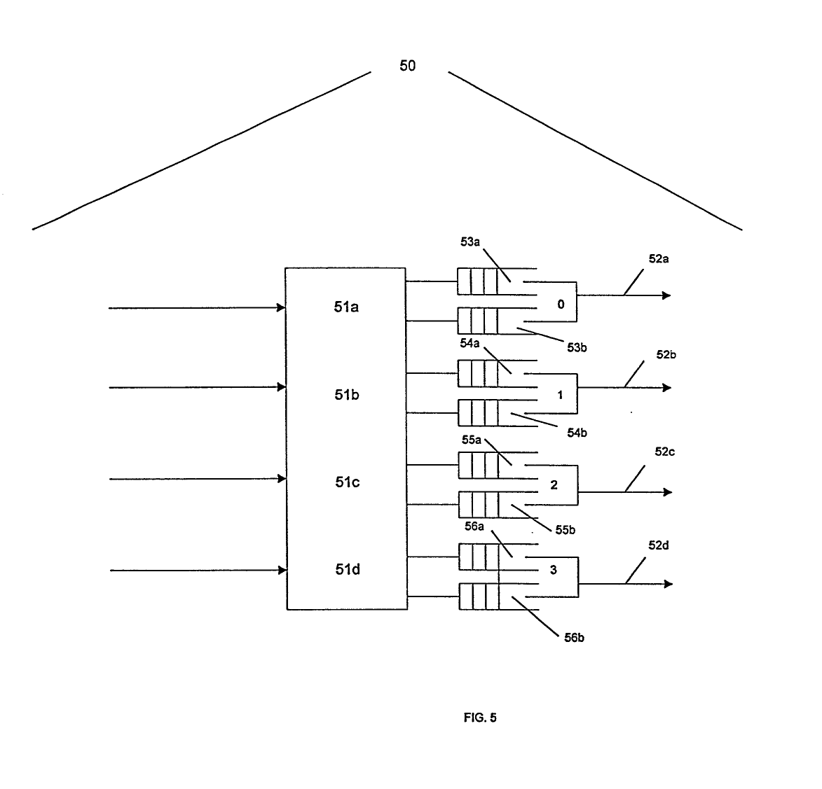

FIG. 5 illustrates one embodiment of a switch 50 that includes buffering elements 53a, 53b, 54a, 54b, 55a, 55b, 56a and 56b, similar to those illustrated in FIG. 4. The embodiment of FIG. 5 has four input ports 51a-51d and four output ports 52a-52d (and hence is a 4×4 switch).

In the example of FIG. 5, there are only two QoS levels. In this example, each output port 52a-52d has two associated queues (one for each QoS level). For example, output port 52a has two associated queues 53a and 53b. Again, while this embodiment illustrates buffering on the output ports, buffering could instead be done on the input ports or on both input and output ports. In addition, while FIG. 5 illustrates queues 53a-56b as separate devices, they may be stored in one, or across several, memory chips or other devices.

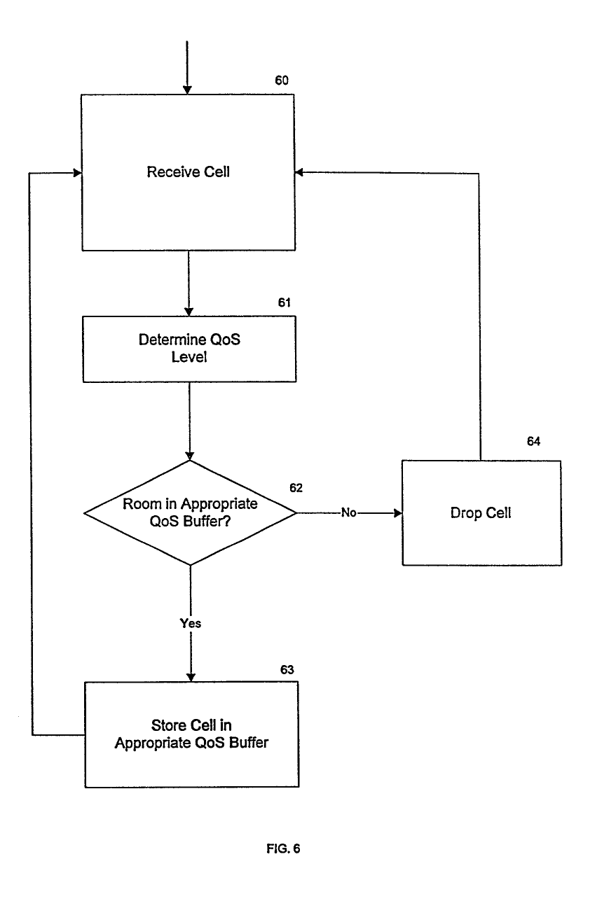

FIG. 6 illustrates one embodiment of a process for receiving cells at a buffering element, such as receiving incoming cells 41 at buffering element 40 of FIG. 4. The process begins at a step 60 when a cell is received. At a step 61, the appropriate QoS level for the cell is determined. This may be done, for example, by examining a field in the cell that specifies or otherwise indicates the QoS level.

At a step 62, it is determined whether there is room in the appropriate QoS buffer to receive the cell. If so, the cell is stored in the buffer, at a step 63. If there is no room in the appropriate QoS buffer, the cell is dropped at a step 64.

Of course, a number of variations on this process may be developed. As just one example, if there is no room in the appropriate QoS buffer (step 62), buffers of a lower priority could be examined. If there is room in a lower priority buffer, the cell could be stored in that buffer (additional steps may be taken when order of cell transmission is important, such as taking cells from the queue out of FIFO order). In any event, a number of variations and optimization may be made to the embodiment of FIG. 6.

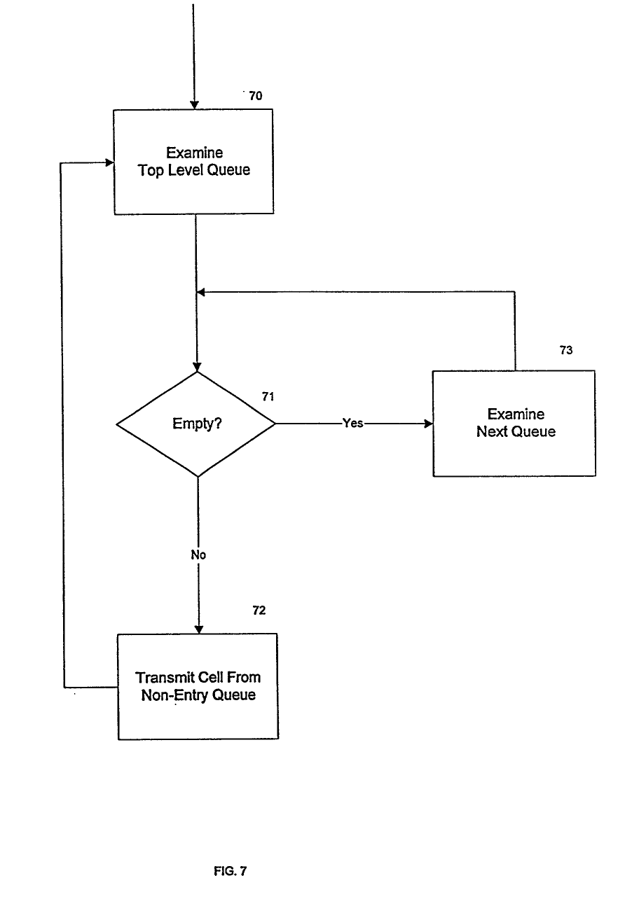

FIG. 7 illustrates one embodiment of a method for retrieving cells stored in a buffering element, such as selecting the outgoing cells 42 of FIG. 4.

In this particular embodiment, the top level queue is selected first (e.g., queue 43a of FIG. 4), at a step 70.

At a step 71, it is determined whether the selected queue is empty. If so, the next queue is selected (at a step 73), and examined to determine if it is empty (step 71).

Once a queue that is not empty has been found, one (or more) cell from that queue is transmitted at a step 72. In this particular embodiment, after a cell has been transmitted, the top level queue is again examined. Accordingly, the effect of the embodiment in FIG. 7 is to transmit cells from the highest level queue that is holding cells, until there are none left.

A number of variations or alternatives are possible. For example, in the embodiment of FIG. 7, a cell in the lowest QoS level queue could be indefinitely frozen from transmission by a long stream of cells arriving for higher level QoS queues. An alternative, therefore, would be to rotate priority among the QoS levels (e.g., give the highest level QoS queue first priority sixty percent of the time, the second highest level priority thirty percent of the time, the third highest level priority ten percent of the time and the lowest QoS level priority none of the time). Another alternative would be to monitor cell delay and require transmission of cells after a certain delay (the delay potentially depending on the QoS level). For example, queue 3 could be given highest priority when cells have been sitting in that queue for longer than a first period of time, and queue 4 given highest priority when cells have been sitting in that queue for a second period of time (in most cases, the period of time for the lower QoS levels will be greater than the period of time for the higher QoS levels). Again, a number of variations and optimizations are possible.

In the embodiment of FIG. 7, cells are removed from the queue on a first in and first out (“FIFO”) basis. Again, a number of alternatives are possible. For example, if a cell is in the highest QoS level queue, but can not be transmitted, another cell may be selected from the highest QoS level queue (or, in the alternative, a cell selected from the next QoS level queue). A cell may not be capable of transmission when, for example, the place to which it is being transmitted is blocked. One example of this situation occurs when the buffers appear at the input ports (e.g., port 14a of FIG. 1). If another port is transmitting a cell to a particular output port (e.g., port 14d), no other cell stored at any other input port can be transmitted to that same port at the same time. Thus, a cell in the highest QoS level associated with port 14a might be blocked from transmission to port 14d by another cell being transmitted to that port.

Referring again to FIG. 4, the buffering element has M queues, where M stands for the number of levels of QoS accommodated by the switch. In the example of FIG. 4, M equals 4.

Referring again to FIG. 5, an N by N switch is disclosed (in FIG. 5, N=b 4). Where buffers appear only on the output (or input), there may be a total of M×N queues in the switch.

In one embodiment of the present invention, each of the queues may have a different depth. That is, the size of each queue may not be the same. In these embodiments, therefore, a problem may be posed of how much memory to provide for each queue, to meet system (and QoS) requirements. This may be referred to as a queue depth assignment problem.

In one embodiment, the assignment of depths to each of the queues is based on performance and characteristic of the network and switch. The depth assignments should satisfy the following equation:

$${\sum }_{i = 1}^{N} {\sum }_{j = 1}^{N} {D}_{ij} \leq m$$

Where m is the total memory available in the switch, Dᵢⱼ is the depth of the queue at port i and QoS level is j. Thus, the sum of the depths of all of the queues has to be less than or equal to the total memory (m) available in the switch. As can be seen from this model, the depth of all of the highest quality level queues within the switch may, but need not, be the same. For example, referring again to FIG. 1, more memory could be provided for the highest level queuing associated with port 14d than with port 14e.

One way to determine queue depth is to ascertain a mathematical model for the quality of the queue depth assignments. The mathematical model can then be solved or used to evaluate possible solutions of the depth assignment problem.

In the following example, an energy function is defined to reflect the measure of the quality of the potential solution of the depth assignment problem. In this example, the lower the energy function, the better the solution. The energy function is:

$$E = {\sum }_{i = 1}^{N} {\sum }_{j = 1}^{N} {P}_{1 j} {f}_{1} ( {D}_{if} , {p}_{ij} ) {λ}_{ij} + {P}_{2 j} {f}_{2} ( {D}_{ij} , {p}_{ij} , {λ}_{ij} ) ,$$

P₁ⱼ is the constant penalty imposed for a dropped cell on QoSj. (For example, with three QoS levels, weights 10, 5 and 1 could be respectively assigned as the penalty for dropping a cell of the corresponding QoS level.)

P₂ⱼ is the penalty imposed for a cell waiting on QoSj. (For example, with three QoS levels, penalties of 8, 4 and 0 could be assigned for each unit time delay of a cell having the corresponding QoS level.)

Pᵢⱼ is the load on port i, QoSj, which is given by pᵢⱼ=λᵢⱼ/μⱼ. Here, λᵢⱼ is the arrival rate, in packets/sec., on port i, QoSj, and μⱼ is the processing rate of QoSj, also in packets/sec.

The function f₁ (D, p) is the cell loss probability. Therefore, f₁, (D, p) λᵢⱼ corresponds to the CLR. The function f₂ (D, p, λ) corresponds to the CTD.

To use the above energy function, the particular variables of the equation have to be filled in. Values of λᵢⱼ may be determined by observing the traffic over the switch for some length of time and averaging arrival rates on each queue. Of course, other methods are possible.

The processing rates μ of each queue may be determined by the switch's performance characteristics (or observed).

The penalty parameter arrays P₁ and P₂ may be determined subjectively by the user. These values represent the relative importance of minimizing each of the objective measures fl and f2 (e.g., CLR and CTD) for each queue. For example, if P₁ =(10, 5, 2, 0), then a penalty of ten is imposed for a lost cell on the first QoS level, a penalty of five on the second QoS level, a penalty of two on the third QoS level, and no penalty on the fourth QoS level. In this example, performance on the fourth QoS level will be sacrificed to improve CLRs of the other QoS levels. Similarly, the penalty associated with cell delay P₂ needs to be specified for each of the QoS levels.

The M/M/1/K queuing model may be used to predict CLR and CTD. This model is discussed, for example in Kleinrock, L., Queuing Systems, Vol I: Theory, New York, N.Y.: John Wiley & Sons, Inc., 1975, pp. 103-5; and Fu, L., Neural Networks in Computer Intelligence, New York, N.Y.: McGraw-Hill, Inc., 1994, pp. 41-5. This model assumes that p <1, where p is the load. The cell loss probability, f₁, is given by

$${f}_{1} ( D , p ) = \frac{( 1 - p ) {p}^{D}}{1 - {p}^{D + 1}}$$

and the CTD is given by

$${f}_{2} ( D , p , λ ) = \frac{p [ 1 - ( D + 1 ) {p}^{D} + D {p}^{D + 1} ]}{( 1 - {p}^{D + 1} ) ( 1 - p ) λ ( 1 - {f}_{1} ( D , p ) )}$$

(A variety of other models may also be used to predict CLR and CTD. CLR and CTD may also be estimated by taking actual measurements on a system while it is performing.)

One possible approach to solving for minimum E is to examine all possible depth assignments. As is typical of combinatorial problems of this nature, however, the cost of exhaustive search grows factorially. The number of feasible solutions is equal to

$$\frac{( m - 1 ) !}{( m - N M ) ! ( N M - 1 ) !} = ( \begin{matrix}m - 1 \\ N M - 1\end{matrix} ) .$$

Table 1 below illustrates a few examples to show the growth of this function.

TABLE 1

| | | number of |
|---|---|---|
| | | possible |
| m | NM | solutions |
| 30 | 10 | 1.00 × 10⁷ |
| 30 | 15 | 7.76 × 10⁷ |
| 40 | 10 | 2.12 × 10⁸ |
| 40 | 20 | 6.89 × 10¹⁰ |
| 100 | 10 | 1.73 × 10¹² |
| 100 | 25 | 6.06 × 10²² |
| 100 | 50 | 5.04 × 10²⁸ |

Under certain embodiments of the present invention, alternative methods may be used to find optimal (or, hopefully, close to optimal) solutions. Thus, neural-networks, genetic algorithms and other approaches may be used.

In one embodiment of the present invention, a straightforward genetic algorithm is used to solve the above energy function. According to this method, an initial solution is started with. This initial solution can be any random solution, or may be selected intelligently as discussed below.

The genetic algorithm then uses a mutation operator that may consist of picking a random port, subtracting a random number from a randomly selected queue on that port and adding that same number to another randomly selected queue depth on the same port. Simple single point cross over may be used to combine solutions. In each generation of the genetic algorithm, an elite percentage of the population is preserved and used to reproduce the remainder of the population using cross over. Half of the offspring may further be mutated a number of times.

In an alternative embodiment, steepest ascent (or descent—they are the same) hill-climbing (SAHC) may be used. This algorithm (in certain environments) may produce similar results to that of the genetic algorithm, although in considerably shorter time in certain applications.

Using steepest descent hill-climbing, a local minimum solution can be found by following the steepest path down the energy surface—following search paths that provide the greatest decreases in the energy function.

The steepest descent hill-climbing approach may be modified to include random jumps. This would permit the algorithm to jump over small “hills” on the energy function surface. This process employs the technique called simulated annealing, known in the art.

The hill-climbing may be achieved by systematically (rather than randomly) incrementing each Dᵢⱼ by one and at the same time reducing the depth of a randomly selected queue by one (thus keeping the total memory usage constant and equal to m). The energy function of each potential solution may be evaluated and the best set of queue depths saved.

For each of the above, an intelligent initial solution can improve the results and/or reduce the amount of time required to achieve a good solution. In one embodiment, the solution is initialized to have queue depths of Dᵢⱼ proportional to pᵢⱼ(P₁ⱼ+P₂ⱼ) and summing to exactly m.

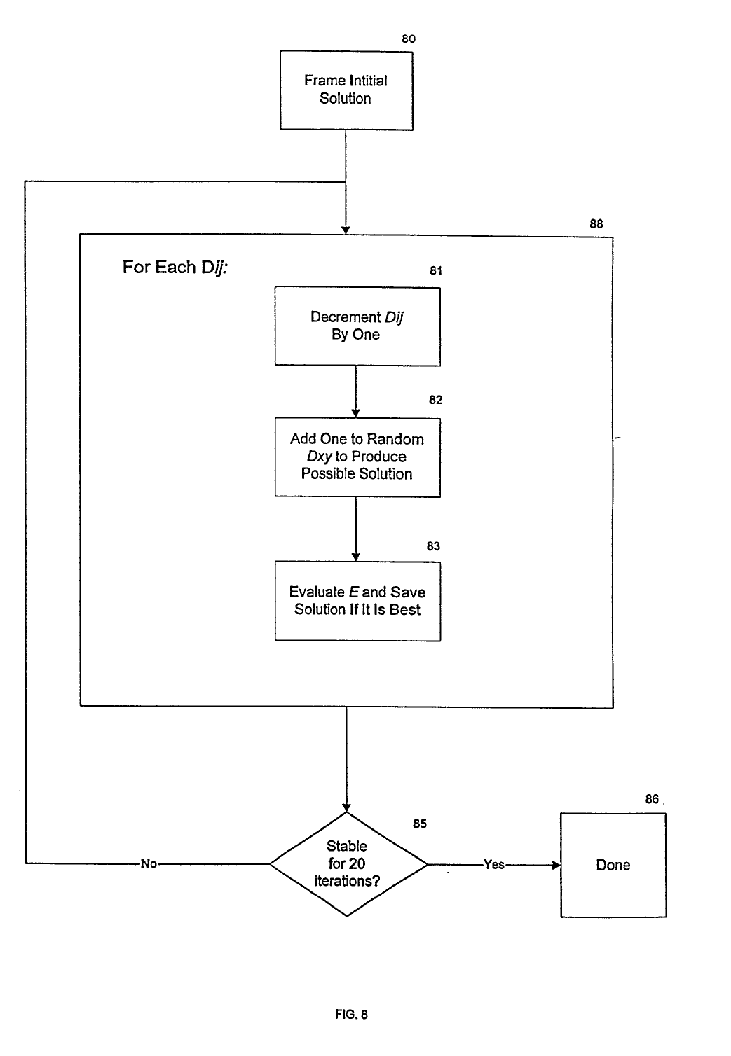

Thus, FIG. 8 illustrates one embodiment of a method for finding a solution to the queue depth assignment problem. This embodiment begins at a step 80, where an initial solution is formed. This solution may be formed as described above, assuming that depths Dᵢⱼ are proportional to pᵢⱼ(P₁ⱼ+P₂ⱼ) and sum to exactly m.

At a step 88, the current best solution is mutated to determine if a better potential solution may be found. The possible solutions are generated at step 88. For each of the queues at the switch (the queue having an associated depth Dᵢⱼ), the applicable Dᵢⱼ is decreased by one. In addition, a randomly selected queue depth D_{xy} is incremented by one. This forms a new potential solution—moving one storage element from a current existing queue to a new queue. By both decrementing and adding one, the total memory for the switch remains the same. (Here, the adding and subtracting of one corresponds to adding and subtracting sufficient storage to accommodate one additional cell).

After the new possible solution is generated, its energy function may be evaluated. If this is the best energy function encountered so far, this solution is saved and used for the next iteration (the next time step 88 is performed). Otherwise processing simply continues and the current solution remains the best one encountered so far. Optionally, in the event of a tie, the newly generated solution is selected.

After examining a variety of potential solutions, at step 88,it is determined whether the algorithm has improved the best solution encountered so far at any point in the last (for example) twenty iterations (twenty times passing through step 88). If not the current best solution is taken as the solution to the queue depth problem. If so, the solution has not been stable for the last twenty iterations—processing continues by returning to step 88 (using the current best solution).

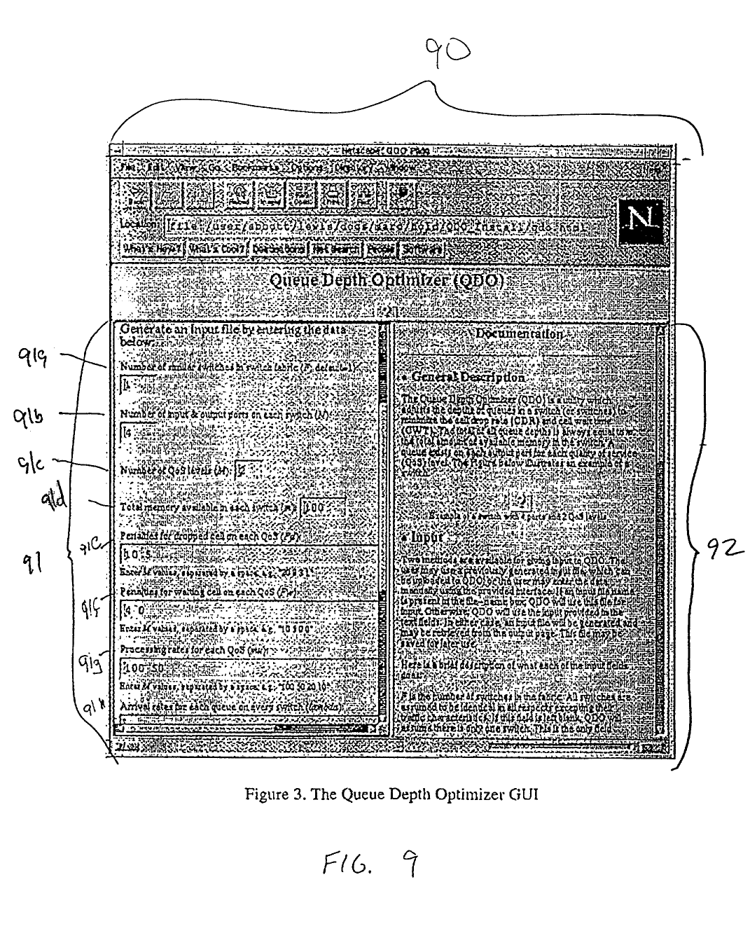

FIG. 9 illustrates one embodiment of a graphical user interface that may be used for solving a queue depth assignment problem. In this particular embodiment, the interface 90 includes an input area 91 and a help area 92. The help area 92 provides a scrollable help document.

As illustrated at 91, the following fields may be input to frame the queue depth assignment problem. A number of switches in the network may be input, as shown at 91a, where more than one switch may be present in the switch fabric.

At 91b, a user may input the number of input and output ports on each switch (N). At 91c, the user may input the number of QoS levels supported by the switch. At 91b, the user may input the total memory available on each switch. (In this embodiment, the input is in terms of the number of cells that can be stored in all of the buffers on the switch.)

At 91e, the user may input the penalty for losing a cell on each QoS level. In the example illustrated in FIG. 9, there are two QoS levels (as shown at 91c). Accordingly, two different entries need to be made at 91e—one for each QoS level.

Similarly, at 91f, the user inputs the penalties for cell delay on each QoS. As above, the number of entries may correspond to the number of QoS levels (again indicated at 91c).

At 91g, the processing rates (μ) for each quality of service level are input. Finally, at 91h, the arrival rates (λ) for each queue on every switch are input. Thus, in this example, eight entries need to be made—one for each of the two queues on each of the for output ports.

Tables 2 and 3 below show examples of application of the algorithm of FIG. 8 to the following queue depth assignment problems. Values for λ were determined by two different methods to stimulate mean and maximum load measures. In Table 2, λ values were determined by taking the mean of five random numbers. In Table 3, λ values are the maximum of five random numbers. In both cases, the constraint λᵢⱼ<μⱼ is enforced.

In all experiments, the number of QoS levels, M=4, P₁=(10, 5, 2, 1), and P₂=(8, 4, 0, 0) Values of μ were 100, 60, 30, 15. The Percent Improvement columns show the improvement over the initial solution (framed using the intelligent solution described above) in each QoS measure for each QoS level. CLRs and CTDs are averaged for each QoS, and are listed in order of QoS level.

TABLE 2

| | | | | | Percent | |
|---|---|---|---|---|---|---|
| | | | Percent | | Improve- | Number of |
| | | Final CLR | Improvement | Final CTD | ment | iterations |
| N | m | (cells/sec.) | (%) | (sec.) | (%) | required |
| 4 | 50 | 0.460 | −278 | 0.0180 | 3.75 | 19 |
| | | 0.864 | 110 | 0.0302 | −9.52 | |
| | | 1.73 | 141 | 0.0442 | −32.6 | |
| | | 2.70 | −21.2 | 0.0667 | 10.0 | |
| 4 | 100 | 0.0400 | −6090 | 0.0189 | 0.763 | 38 |
| | | 0.741 | −7.81 | 0.0344 | 0.102 | |
| | | 0.205 | 1040 | 0.0600 | −44.1 | |
| | | 0.374 | 622 | 0.118 | −76.8 | |
| 4 | 200 | 0.000538 | −6.22 × 10⁶ | 0.0190 | 0.0174 | 87 |
| | | 0.00109 | −79.1 | 0.0351 | 0.0208 | |
| | | 0.00233 | 36100 | 0.0659 | −27.5 | |
| | | 0.00653 | 19000 | 0.145 | −62.9 | |
| 6 | 100 | 0.154 | −722 | 0.0184 | 2.00 | 39 |
| | | 0.348 | 32.1 | 0.0306 | −1.20 | |
| | | 0.910 | 441 | 0.0542 | −62.7 | |
| | | 1.39 | 48.9 | 0.0827 | −12.8 | |
| 6 | 200 | 0.00838 | −70400 | 0.0188 | 0.197 | 82 |
| | | 0.0184 | −53.1 | 0.0328 | 0.154 | |
| | | 0.0414 | 5920 | 0.0689 | −55.1 | |
| | | 0.0795 | 2190 | 0.129 | −66.7 | |
| 12 | 200 | 0.179 | −991 | 0.0184 | 2.41 | 76 |
| | | 0.313 | 76.6 | 0.0310 | −3.32 | |
| | | 0.773 | 504 | 0.0544 | −61.2 | |
| | | 1.44 | 59.2 | 0.0791 | −18.7 | |
| 12 | 500 | 0.00172 | −3.68 × 10⁵ | 0.0190 | 0.0502 | 94 |
| | | 0.00304 | −38.1 | 0.0331 | 0.0238 | |
| | | 0.0104 | 10700 | 0.0675 | −30.4 | |
| | | 0.0194 | 9070 | 0.133 | −76.2 | |
| 20 | 200 | 0.914 | −69.5 | 0.0182 | 3.49 | 51 |
| | | 1.76 | 49.0 | 0.260 | −7.28 | |
| | | 3.79 | 28.8 | 0.0372 | −11.7 | |
| | | 2.46 | −2.29 | 0.0667 | 1.43 | |
| 20 | 500 | 0.0387 | −3644 | 0.0200 | 0.798 | 155 |
| | | 0.0763 | 26.4 | 0.0320 | −0.469 | |
| | | 0.225 | 1410 | 0.0633 | −59.2 | |
| | | 0.415 | 353 | 0.110 | −45.5 | |
| 20 | 1000 | 0.000572 | −4.14 × 10⁵ | 0.0201 | 0.0204 | 369 |
| | | 0.00107 | −160 | 0.0327 | 0.0286 | |
| | | 0.00282 | 28100 | 0.0695 | −25.4 | |
| | | 0.00663 | 24700 | 0.140 | −76.0 | |

TABLE 3

| | | | | | Percent | |
|---|---|---|---|---|---|---|
| | | | Percent | | Improve- | Number of |
| | | Final CLR | Improvement | Final CTD | ment | iterations |
| N | m | (cells/sec.) | (%) | (sec.) | (%) | required |
| 4 | 50 | 6.31 | −5.14 | 0.0345 | 2.69 | 7 |
| | | 7.46 | 8.30 | 0.0345 | −4.71 | |
| | | 9.28 | 0.00 | 0.0333 | 0.00 | |
| | | 5.89 | 0.00 | 0.0667 | 0.00 | |
| 4 | 100 | 2.12 | −30.0 | 0.0553 | 7.34 | 20 |
| | | 2.74 | 5.94 | 0.0561 | −3.48 | |
| | | 3.41 | 172 | 0.0612 | −83.5 | |
| | | 5.89 | 0.00 | 0.0667 | 0.00 | |
| 4 | 200 | 0.568 | −22.2 | 0.0827 | −0.427 | 46 |
| | | 0.772 | 3.70 | 0.0875 | −5.92 | |
| | | 1.04 | 240 | 0.100 | 967.6 | |
| | | 2.00 | 128 | 0.148 | −67.5 | |
| 6 | 100 | 4.48 | −11.1 | 0.0424 | 4.07 | 12 |
| | | 5.20 | 9.81 | 0.0427 | −4.40 | |
| | | 5.83 | 28.1 | 0.0434 | −14.4 | |
| | | 6.06 | 0.00 | 0.0667 | 0.00 | |
| 6 | 200 | 1.43 | −28.3 | 0.0674 | 4.12 | 34 |
| | | 1.73 | 5.10 | 0.0689 | −2.45 | |
| | | 2.34 | 187.4 | 0.0711 | −71.4 | |
| | | 3.77 | 50.1 | 0.0975 | −35.4 | |
| 12 | 200 | 4.84 | −12.1 | 0.0435 | 5.92 | 36 |
| | | 5.31 | 8.05 | 0.0424 | −2.54 | |
| | | 6.17 | 36.2 | 0.0435 | −21.1 | |
| | | 5.82 | 0.00 | 0.0667 | 0.00 | |
| 12 | 500 | 1.07 | −23.9 | 0.0807 | 2.74 | 79 |
| | | 1.23 | 3.01 | 0.0797 | −2.48 | |
| | | 1.71 | 138 | 0.0867 | −51.8 | |
| | | 2.70 | 84.9 | 0.0120 | −52.0 | |
| 20 | 200 | 9.36 | −3.27 | 0.0293 | 1.78 | 14 |
| | | 11.3 | 6.02 | 0.0284 | −3.47 | |
| | | 10.0 | 0.00 | 0.0333 | 0.00 | |
| | | 5.52 | 0.00 | 0.0667 | 0.00 | |
| 20 | 500 | 2.46 | −15.0 | 0.0575 | 3.37 | 57 |
| | | 2.98 | 6.22 | 0.0595 | −2.79 | |
| | | 4.38 | 94.1 | 0.0579 | −46.7 | |
| | | 5.52 | −3.89 | 0.0667 | 4.29 | |
| 20 | 1000 | 0.731 | −27.1 | 0.0870 | 2.03 | 208 |
| | | 0.902 | 2.74 | 0.0919 | −3.02 | |
| | | 1.41 | 205 | 0.108 | −78.9 | |
| | | 1.94 | 115 | 0.140 | −58.5 | |

As shown in Tables 2 and 3, the new solution is not always superior to the initial solution in all respects. Specifically, the CTD is often worse in the final solution than initially. However, the overall goodness of the solution has improved—some aspects of performance have been sacrificed in order to provide improved measures of aspects deemed more important. In these experiments, CTD was given a comparatively lower priority than CLR, resulting in decreased levels of performance in the CTD measure.

Some of the percentage improvements listed are extremely large in magnitude. These values can be misleading, since the initial quantity may be small. Therefore, even though the percentage is large, the absolute change may be of only marginal significance.

A number of problems were also solved by exhaustive search in order to objectively determine optimal solutions for comparison to the SAHC solutions. In every case, the SAHC algorithm found an optimal solution. The problems sizes were necessarily very small, on the order of 10⁶ to 10⁷ . It should be noted, however, that exhaustive search on even these small problems took hours of computation running on a Silicon Graphics Indigo 2 workstation, while the SAHC method was able to arrive at the same solutions in less than one second.

In the above examples, it is assumed that memory could be allocated across all of the buffers in the network. This works well for initial system design.

In an existing system, however, the buffering memories may not be easily reallocated between ports. Referring again to FIG. 1, each of the buffering components 16d-16f are connected to a respective port. After the switch has been designed and built, it may not be convenient to move memory from one of the buffering elements (e.g., 16d) to another buffering element (e.g., 16e). Where this is the case, it may still be possible to optimize queue depths within the individual buffering elements even after the switch has been constructed, without a shared pool of memory for all buffers on the switch. For example, if each of the queues 43a-43d (of FIG. 4) are stored in a common memory, the amount of memory allocated to each of the buffers may be dynamically changed easily. The technique for assigning queues may be the same as that described above, except that fewer queues are analyzed.

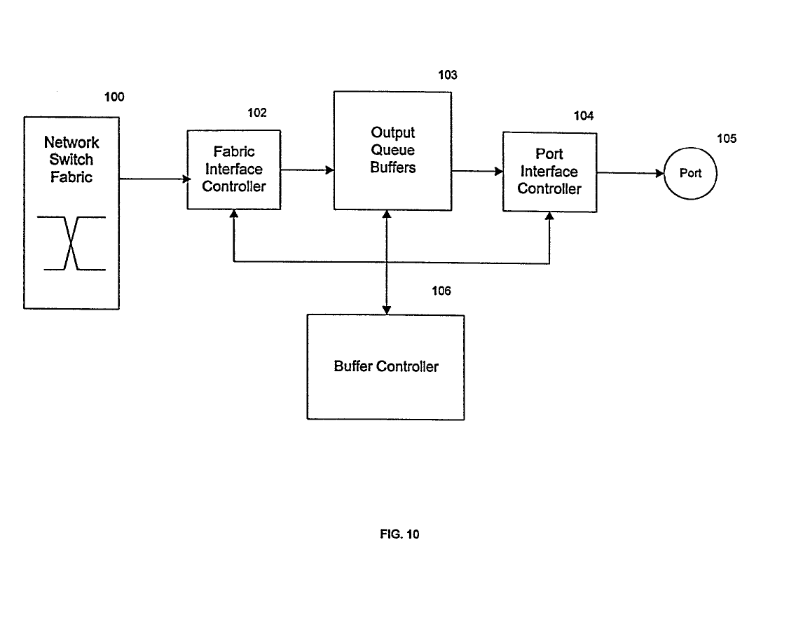

FIG. 10 illustrates one embodiment of a buffering unit according to one embodiment of the present invention, such as the buffering unit 16d of FIG. 1. In this embodiment, a fabric interface controller 102 handles reception of cells from the network switch fabric 100 (in 16d of FIG. 1, this would correspond to reception of cells from the network switch fabric 12). The fabric interface controller may provide cells to the output queue buffers 103 at the direction of a buffer controller 106. Similar to the fabric interface controller 102, a port interface controller 104 handles transmission or reception of cells from the port 105. Both the fabric interface controller 102 and the port interface controller 104 may be implemented as off the shelf devices, or may be integrated into an application specific integrated circuit (ASIC) that includes all or part of the components shown in FIG. 10.

The output queue buffers 103 may be a single dedicated memory device, several memory devices, registers, or a portion of a total memory space used within the switch. As described above, the latter most easily permits assignment and re-aligning of memory among buffering components associated with individual ports, whereas other embodiments may not as easily accommodate this.

In one embodiment, the buffer controller 106 performs the control functions of FIGS. 6-8. This may be done by responding to requests from the fabric interface controller 102 and the port interface controller 104 and controlling the output queue buffers 143 accordingly. In other embodiments, either or both of the fabric interface controller 102 and port interface controller 104 perform some or all of these control functions (as illustrated in FIG. 4), so that a buffer controller 106 is not necessary. In another embodiment, the buffer controller 106 performs the functions of the fabric interface controller 102 and port interface controller 104

The above embodiments also permit dynamic monitoring of network characteristics for the switch or port, and reassignment of queue depths on the fly.

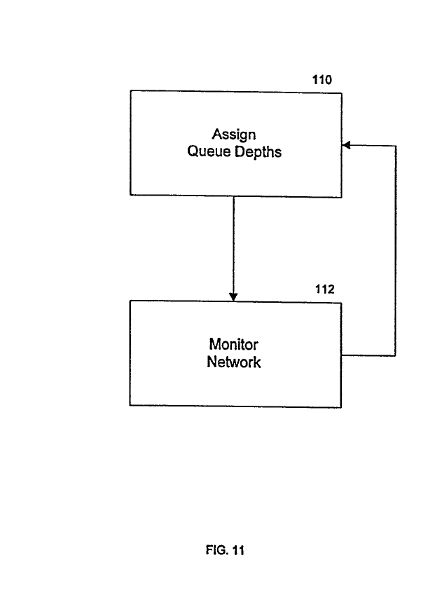

FIG. 11 illustrates one embodiment of this process. According to this embodiment, queue depths are assigned at a step 110. This may be done initially as described above, by making assumptions or estimates about network characteristics.

At a step 112, the network characteristics are monitored. These characteristics may correspond to whatever aspects affect the energy function used in the particular embodiment. For example, in the embodiments described above, mean cell arrival rates (λ), cell drop rates, cell delay rates, average throughput, etc. may be measured. This monitoring may be done by the buffer controller, separate monitoring module, a network controller or other mechanism.

Periodically, the queue depths may be reassigned, by returning to step 110. This may be done at fixed periods of time (e.g., once a day), or may be done whenever a change in network characteristics is sensed. By logging the network characteristics, a schedule of queue depths may be created. This may be useful where the characteristics of the network vary over time (e.g., where network characteristics in the evening are different than network characteristics in the morning).

The process of assigning queue depths 110 may be performed by buffer controllers, as described above with reference to FIG. 10. Even where all of the buffers are held in a common memory and queue depths may be reassigned by sharing memory across more than one port, one or more buffer controllers may be responsible for assigning queue depths. In alternative embodiments, a separate processor may be provided for performing or coordinating the queue depth assignment problem, or this process may be performed by a network controller or other facility.

The various methods above may be implemented as software on a floppy disk, compact disk, or other storage device, which controls a computer. The computer may be a general purpose computer such as a work station, main frame or personal computer, that performs the steps of the disclosed processes or implements equivalents to the disclosed block diagrams. Such a computer typically includes a central processing unit coupled to a random access memory and a program memory by a data bus of some form. The data bus may also be coupled to the output queue. The buffer controller 106 may, for example, perform these functions and be implemented in this manager. Alternatively, the various methods may be implemented in hardware such on an ASIC or other hardware implementation. Of course, in either hardware or software embodiments, functions performed by the above elements and the varying steps may be combined in varying arrangements of hardware and software.

Having thus described at least one illustrative embodiment of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A buffer element for a communication network, the buffer element comprising:
a first buffer memory to store communication units corresponding to a first quality of service level;
a second buffer memory to store communication units corresponding to a second quality of service level; and
a buffer manager, coupled to the first buffer memory and the second buffer memory, to selectively store communication units in the first buffer and the second buffer based on a corresponding quality of service level of the communication units, and to retrieve communication units from the first buffer memory and the second buffer memory.

2. The buffer element of claim 1, wherein the buffer manager comprises:
a sorter unit coupled to the first buffer memory and the second buffer memory to selectively store a communication unit in the first buffer or the second buffer based on a quality of service level of the communication unit.

3. The buffer element of claim 1, wherein the first buffer memory has a first depth, the second buffer memory has a second depth, and the buffer element further comprises:
a depth adjuster to adjust the first depth and the second depth.

4. The buffer element of claim 3, wherein the depth adjuster comprises:
means for iteratively searching possible depth assignments to determine the first depth and the second depth.

5. The buffer element of claim 4, wherein the means for searching comprises:
means for performing a steepest ascent hill climbing search.

6. The buffer element of claim 3, wherein the depth adjuster comprises:
means for determining performance characteristics of the switch.

7. The buffer element of claim 1, wherein the first buffer memory and the second buffer memory are regions of memory in a contiguous random access memory device.

8. The buffer element of claim 1, wherein the communication units are ATM cells.

9. A switch for a communication network, the switch comprising:
a plurality of ports;
a first buffer memory coupled to one of the ports to store communication units corresponding to a first quality of service level; and
a second buffer memory coupled to the one of the ports to store communication units corresponding to a second quality of service level.

10. The switch of claim 9, further comprising:
a buffer manager, coupled to the first buffer memory and the second buffer memory, to selectively store communication units in the first buffer and the second buffer based on a corresponding quality of service level of the communication units, and to retrieve communication units from the first buffer memory and the second buffer memory.

11. The switch of claim 9, wherein:
the plurality of ports comprises a plurality of output ports that output communication units from the switch to the network; and
the first buffer memory and the second buffer memory are coupled to one of the plurality of output ports, to store communication units to be output to the one of the plurality of output ports.

12. The switch of claim 11, wherein:
each of the plurality of output ports has a respective first buffer memory and a respective second buffer memory to store communication units transmitted across the respective output port.

13. The switch of claim 12, wherein:
each of the plurality of output ports has a respective buffer manager to selectively store communication units in the respective first buffer and the respective second buffer based on a corresponding quality of service level of the communication units, and to retrieve communication units from the respective first buffer memory and the respective second buffer memory.

14. The switch of claim 9, wherein:
the plurality of ports comprises a plurality of input ports that receive communication units from the switch to the network; and
the first buffer memory and the second buffer memory are coupled to one of the plurality of input ports, to store communication units received on the one of the plurality of input ports.

15. The switch of claim 14, wherein:
each of the plurality of input ports has a respective first buffer memory and a respective second buffer memory to store communication units transmitted across the respective input port.

16. The switch of claim 15, wherein:
each of the plurality of input ports has a respective buffer manager to selectively store communication units in the respective first buffer and the respective second buffer based on a corresponding quality of service level of the communication unit, and to retrieve communication units from the respective first buffer memory and the respective second buffer memory.

17. The switch of claim 15, wherein the communication units are ATM cells.

18. A method buffering communication units in a communication network, the method comprising steps of:
assigning a queue depth for each of a plurality of queues, each queue being designated to store communication units of a predetermined quality of service level;
providing the plurality of queues, each queue having the corresponding assigned depth;
selecting one of the queues to receive a communication unit based on a quality of service level associated with the communication unit; and
storing the communication unit in the selected queue.

19. The method of claim 18, further comprising a step of adjusting the queue depths.

20. The method of claim 18, further comprising steps of:
monitoring a characteristic in the communication network; and
adjusting the assigned queue depths based on the monitored characteristic.

21. The method of claim 20, wherein the characteristic is selected from the group consisting of communication unit arrival rate for one of the quality of service levels, communication unit processing rate for one of the quality of service levels, communication unit loss rate for one of the quality of service levels and communication unit delay rate for one of the quality of service levels.

22. The method of claim 18, wherein each of the plurality of queues stores communication units for a single port in a communication network switch.

23. The method of claim 22, wherein the single port is an output port.

24. The method of claim 18, wherein the plurality of queues stores the communication units for each port of a switch in the communication network.

25. The method of claim 18, wherein the assigning step comprises a step of:
determining a priority level for dropped communication units for each of the quality of service levels.

26. The method of claim 18, wherein the assigning step comprises a step of:
assigning a priority level for communication unit delay for each of the quality of service levels.

27. The method of claim 18, wherein the assigning step comprises a step of:
performing a search of possible depth assignments.

28. The method of claim 27, wherein the performing step comprises a step of:
performing a steepest ascent hill climbing search.

29. The method of claim 18, wherein the communication units are ATM cells.

30. A method of selecting a communication unit, for transmission in a communication network that provides a plurality of quality of service levels, the communication unit being selected from a plurality of communication units stored in a buffer, the buffer including a plurality of queues, each queue corresponding to one of the quality of service levels, the method comprising steps of:
identifying the queue with the highest corresponding quality of service level and which is not empty; and
selecting the communication unit from the identified queue.

31. A method of storing a communication unit in a buffer, the communication unit having one of a plurality of quality of service levels, the buffer including a plurality of queues, each queue corresponding to one of the quality of service levels, the method comprising steps of:
determining the quality of service level of the communication unit; and
storing the communication unit in the queue having the corresponding quality of service level of the communication unit.

32. The method of claim 31, further comprising a step of:
dropping the communication unit when the queue having the quality of service level of the communication unit is full.
